(19) United States
(12) Patent Application Publication
(10) Pub. No.: US 2009/0280740 A1
(43) Pub. Date: Nov. 12, 2009

(54) AUDIENCE AND SPEAKER INTERACTIVE COMMUNICATIONS SYSTEM

(75) Inventors: Phanish Hanagal Srinivasa Rao, Bangalore (IN); Sherin Sasidharan, Bangalore (IN); Narendran Rajan M., Bangalore (IN)

Correspondence Address: TEXAS INSTRUMENTS INCORPORATED, P O BOX 655474, M/S 3999, DALLAS, TX, 75265, US

(73) Assignee: Texas Instruments Inc., Dallas, TX (US)

(21) Appl. No.: 12/118,329

(22) Filed: May 9, 2008

(51) Int. Cl. H04H 20/71

(52) U.S. Cl. 455/3.05

(57) ABSTRACT

An audience and speaker interactive communications system is described. In one embodiment, it includes a server coupled to a loudspeaker, which server includes an application module for receiving and decoding speech samples and transmitting the speech samples to a loudspeaker over an unlicensed wireless communication frequency spectrum. The system also includes a mobile communications device with a connectivity application for gaining access to the server over an unlicensed wireless communication frequency spectrum as well as a client application module for encoding and transmitting speech samples to the server.

### TECHNICAL FIELD OF THE INVENTION

The invention is directed, in general, to a communication system and, more specifically, to a wireless communication system for providing interaction between a speaker and an audience.

### BACKGROUND OF THE INVENTION

A person delivering a speech, lecture or other presentation to an audience frequently invites members of the audience to offer commentary or ask questions. The typical arrangement is for the speaker to reserve time at the end of the presentation for the audience to ask questions or offer commentary. In appropriate cases, particularly in a lecture or teaching environment, the speaker may invite audience members to interrupt his or her speech and ask questions or offer commentary during the presentation.

If the speech or presentation is given in a large room, such as a lecture hall or auditorium, both the speaker's voice as well as that of the person asking a question or offering commentary must be amplified. For the speaker, this is not a problem because he or she will be either “miked” or will be talking directly into a microphone. However, members of the audience typically do not have instant access to a microphone. The two major prior art methods or approaches used in order to provide audience members access to a microphone were to provide multiple stand alone microphones or to pass a hand held microphone to the person with a question or commentary.

Prior to the advent of wireless microphones, the general practice was to use stand alone microphones. When a member of the audience wanted to ask a question or offer a comment, he or she had to move from his or her seat and proceed to the microphone location. In the time interval between the time the audience member leaves his or her seat and arrives at the microphone, the question or commentary may no longer be topical. In addition, during the lapse of time a queue may have formed because those closer to the microphone location arrived first. This is not only an inconvenience to audience members who have questions or commentary, but it can also serve to make the speaker's presentation somewhat disjointed.

The prior art method of providing audience members a portable wireless microphone does not overcome the problems of using fixed microphone locations. To obtain the wireless microphone, the audience member must first attract the attention of the party controlling the microphone and then wait until it is passed to him or her. Thus, the later method still has the same latency problems as the former. In addition, it suffers the disadvantages of the audience member not being able to attract the attention of the party in charge of the microphone in order to obtain access and of the microphone being intercepted by another audience member while enroute.

In an effort to overcome the problems inherent in the forgoing prior art methods, directional microphones have been occasionally used. However, directional microphones can only be used in small venues that have near perfect acoustics, which also means that the size of the audience must be limited. There still remains the problem of an audience member attracting the attention of the person managing the directional microphone in order to be heard.

SMS (Short Message Service) based technology has also been suggested as a method to relay commentary and questions between an audience member and a speaker. However, SMS based technology is a less than satisfactory solution. Not only does SMS based technology require audience members to have a highly developed proficiency in text messaging in order to offer commentary or ask complicated questions, but it also eliminates responsive interaction between the audience member and the speaker. It also makes any interaction sterile because neither the speaker nor the rest of the audience can hear the questioner's emotive content when offering commentary or asking a question.

Accordingly, what is needed in the art is a system for audience members to interact with a speaker without being required to leave their seat or assigned location in order to ask a question or offer commentary and without being dependent upon another party to provide access to a microphone.

### SUMMARY OF THE INVENTION

To address the above-discussed deficiencies of the prior art, an audience and speaker interactive communications system is described. In one embodiment, the system provides for a server, coupled to a loudspeaker that includes an application module for receiving and decoding speech samples and transmitting the speech samples to the loudspeaker. The system also provides for a mobile communications device with a connectivity application for gaining access to the server over an unlicensed wireless communication frequency spectrum. The mobile communications device also includes a client application module for encoding and transmitting speech samples to the server over the unlicensed wireless communication frequency spectrum.

An embodiment of a method of manufacturing an audience and speaker interactive communications system is also described. In one embodiment, the method calls for the provision of a server coupled to a loudspeaker that includes an application module for receiving and decoding speech samples and transmitting the speech samples to the loudspeaker. The method also calls for a mobile communications device to be provided that has a connectivity application for gaining access to the server over an unlicensed wireless communication frequency spectrum that includes a client application module for encoding and transmitting speech samples to the server over the unlicensed wireless communication frequency spectrum.

### BRIEF DESCRIPTION OF THE DRAWINGS

For a more complete understanding of the invention, reference is now made to the following descriptions taken in conjunction with the accompanying drawings, in which:

FIG. 1 illustrates a block diagram of an embodiment of an audience and speaker interactive communications system constructed in accordance with the present invention;

FIG. 2 illustrates a schematic representation of the operation of an embodiment of an audience and speaker interactive communications system constructed in accordance with the present invention; and

FIG. 3 illustrates a block diagram of an embodiment of a method of manufacturing an audience and speaker interactive communications system in accordance with the present invention.

### DETAILED DESCRIPTION

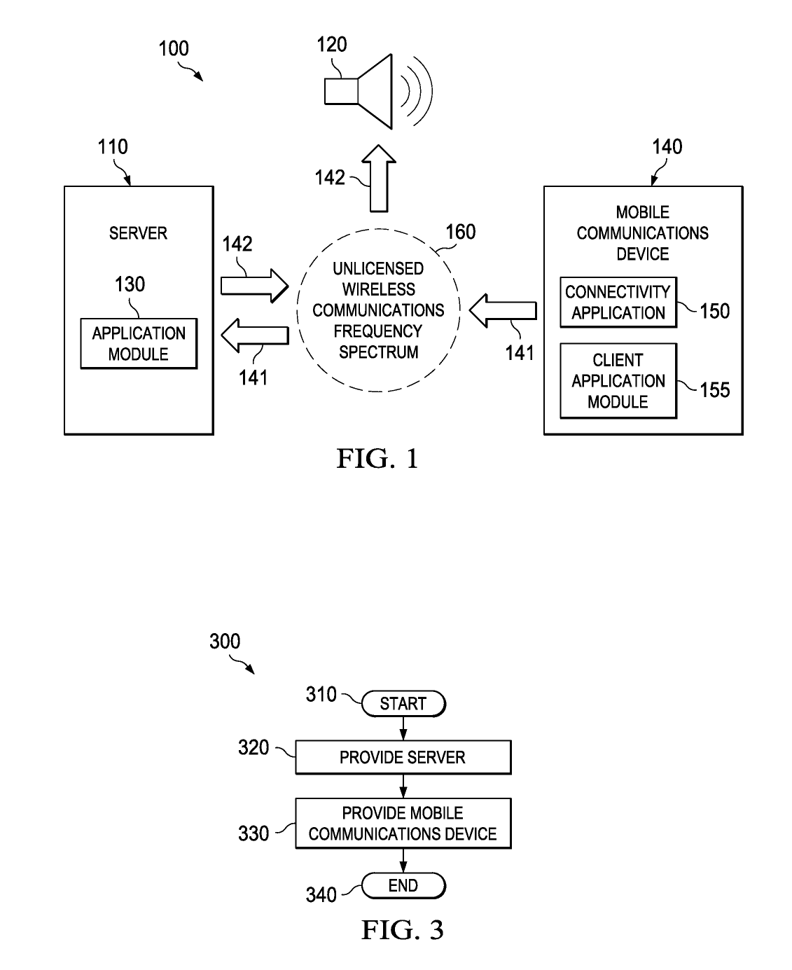

FIG. 1 illustrates a block diagram of an embodiment of an audience and speaker interactive communications system 100 constructed in accordance with the present invention. The system 100 includes a server 110 coupled to a loudspeaker 120 over an unlicensed wireless communications frequency spectrum 160, as illustrated by arrows 142. In another embodiment of the invention, the server 110 can be connected directly to the loudspeaker 120 by wire, cable or other direct means. The server 110 includes an application module 130 for receiving and decoding speech samples and transmitting these speech samples to the loudspeaker 120 over the unlicensed wireless communications frequency spectrum 160.

The system 100 provides for a mobile communications device 140 with a connectivity application 150 for gaining access to the server 110 over the unlicensed wireless communications frequency spectrum 160, as illustrated by arrows 141. The wireless communications frequency spectrum 160 is not limited to a specific frequency spectrum. In can, for example, be the frequency over which Bluetooth™ enabled devices operate or it can be a WiFi™ (WiFi Alliance) radio frequency spectrum or a WiMax™ (Worldwide Interoperability for Microwave Access) enabled frequency spectrum and be within the intended scope of the present invention. The mobile communications device 140 also includes a client application module 155 for encoding and transmitting speech samples to the server 110.

When a user of a mobile communications device 140 wants to ask a question or make a comment during a presentation, the mobile communications device 140 transmits speech samples 141 to the server 110. The speech samples are decoded by the server 110, which transmits the decoded samples 142 to the loudspeaker 120.

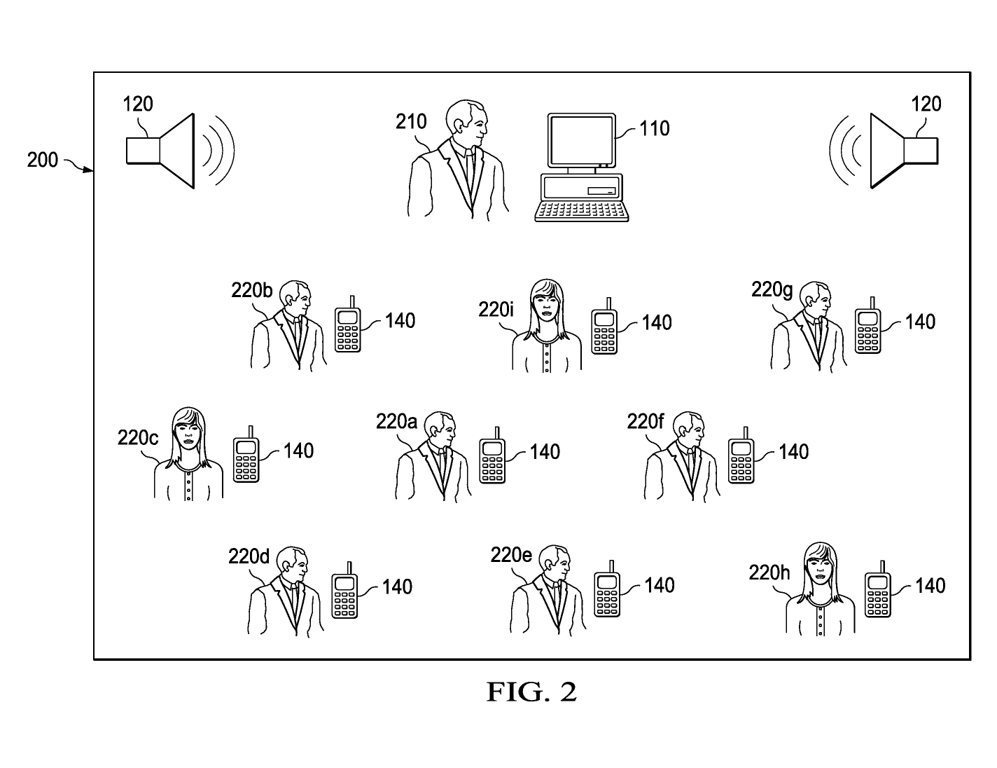

Turning now to FIG. 2, illustrated is a schematic representation of the operation of an embodiment of an audience 220a-220i and speaker 210 interactive communications system 100 constructed in accordance with the present invention. The illustrated layout is representative of a typical audience 220a-220i in a lecture hall 200, meeting room, or other forum where a speaker 210, who may be a teacher, lecturer or any other person, is making a presentation. The illustrated lecture hall 200 could also be a parliamentary or legislative assembly where the members of the audience 220a-220i are parliament members or members of the legislative body and still be within the intended scope of the present invention. The illustrated communications system would replace the microphone set up currently being used in most legislative bodies. The lecture hall 200 could also be a theater or reenactment scene where a theatrical production or historical reenactment is presented where the audience members 220a-220i are actors or reenactment participants.

Members of the audience 220a-220i will have mobile communications devices 140 that, in most cases, will be mobile phones. One advantage of the present invention is that additional microphones do not need to be installed in the lecture hall 200, because the audience 220a-220i will already have them in the form of ubiquitous mobile phones 140.

In most presentations, the speaker 210 will typically ask or invite the audience 220a-220i to ask questions or offer commentary. In some formats, the speaker 210 will invite audience 220a-220i participation during the course of the presentation, although the more usual format is to allow time for questions and answers following the main body of the presentation.

Most prior art systems required audience members 220a-220i who wanted to comment or ask a question to wait until a microphone was made available. This is a necessity in those cases where the presentation is made in a large auditorium or lecture hall 200. As noted previously, prior art systems either required a microphone to be passed to each audience member 220a-220i wanting to ask a question or offer a comment, or the individual audience member 220a was required to proceed to a specific microphone station in order to offer a comment or ask a question. As noted, this is a general inconvenience to the person with a question as well as an interruption to the speaker 210 that can corrupt the flow of his or her presentation. In addition, certain members of the audience 220a-220i may decide not to participate solely because microphone access is inconvenient or difficult.

When a system constructed in accordance with the present invention is used, the members of the audience 220a-220i will have immediate access to a microphone, if they have their mobile phone or other mobile communications device 140 with them. Thus, if audience member 220a has a question or wants to make a comment, he or she can dial a predetermined number on his or her mobile phone 140. Of course other methods of accessing the server 110 could also be used and be within the intended scope of the present invention. For example, one button on the mobile phone 140, such as the # or * key, or other wireless communications device could be dedicated to accessing the server 110. An application for accessing the server 110 could also be loaded or programmed into the mobile communications device and be within the intended scope of the present invention.

The associated connectivity application will access the server 110 over an unlicensed wireless communication frequency spectrum mutually accessible to both the server 110 and the mobile phone 140. In one embodiment of the invention, the server 110 is a laptop, a palm PC, a notebook or a personal computer. As will be readily apparent to those skilled in the art, any computer can be used as a server 110 and be within the intended scope of the present invention. When the mobile communications device 140 and the server 110 are Bluetooth™ enabled, the unlicensed wireless spectrum will be that utilized by the Bluetooth™ application. By the same token, when WiFi or WiMax applications are used, the unlicensed wireless spectrum will be that utilized by such applications.

After accessing the server 110, a client application module in the wireless communications device will encode the audience member's 220a speech and transmit the encoded speech samples to the server 110. The server 110 will receive and decode the speech samples and transmit them to a loudspeaker 120 so the entire audience 220a-220i can hear the question or comment.

To provide some degree of order to a presentation, certain embodiments of the invention can be usefully employed. In certain cases, limitations may be imposed on who in an audience 220a-220i will be entitled to ask questions or offer commentary. For example, the speaker 210 may be giving a lecture to a college class composed of students that paid tuition to be present and non-students who are auditing the class solely for its content. Since the focus will be on the tuition paying students, the speaker 210 may want to limit questions or commentary to those students. The speaker 210 can then opt to use an embodiment of the invention requiring members of the audience 220a-220i entitled to ask questions or offer commentary to register their mobile communications devices 140 with the server 110 before it will accept communications from that device 140. Another situation where access could be limited would be where the audience 220a-220i is large and the speaker 210 wants to limit participation only to preferred audience members 220a-220i such as, for example, to those who are expert in a particular field of endeavor.

Frequently more than one audience member 220a-220i may want to ask a question or offer commentary at the same time. In another embodiment of the invention, the application module will arbitrate between two or more mobile communications devices 140 and only allow access to the winner of such arbitration. In another embodiment of the invention, the application module will communicate the arbitration result to the loser or losers of the arbitration. This embodiment may further arbitrate and place the loser or losers in a queue for access.

In order to provide a speaker 210 an enhanced degree of control over his or her presentation, one embodiment of the present invention allows the speaker to control when members of the audience 220a-220i may access the server 110. Thus, the speaker 210 will be the final arbiter of whether an audience member 22a-220i can ask a question or make a comment. For example, if a number of people in the audience 220a-220c want to ask a question at the same time, the application module can arbitrate and permit audience member 220a to ask his or her question while putting audience members 220b and 220c in a queue. The speaker 210 can then control when, or even if, the next person in the queue is given access.

A number of different criteria can be used to determine a winner in arbitration. The present invention can use such criteria as deemed appropriate by a speaker 210, which can be programmed into the application module. Perhaps the simplest and most logical criterion is that of first come-first served. Thus, one embodiment of the present invention provides for the application module to arbitrate between communications from two or more mobile communications devices 140 based on the time of receipt. In another embodiment, the application module can be programmed to arbitrate between communication devices 140 based on the identity of the user of the mobile communications device 140. For example, the speaker 210 may be an expert on a panel of similar experts that are gathered to make a presentation about a specific topic. Because each member of the panel is knowledgeable about some aspect of the topic, the application module can be programmed so that the winner of an arbitration, when one of the parties to the arbitration is a panel member, will be the panel member when the other party to the arbitration is not a panel member. As will be appreciated by those skilled in the pertinent art, other criteria can be used to arbitrate between the relevant mobile communications devices and still be within the intended scope of the present invention.

Turning now to FIG. 3, illustrated is a block diagram of a method of an embodiment of manufacturing 300 an audience and speaker interaction communications system constructed in accordance with the present invention. The method commences with a start step 310. In a provide server step 320, a server coupled to a loudspeaker is provided. The server includes an application module to receive and decode speech samples and transmit them to the loudspeaker. The server can be any type of computer, such as the speaker's laptop. In one embodiment, the server is selected from a group consisting of a laptop, a palm PC, a notebook computer, and a personal computer. Any computer device capable of performing the required functions would be within the intended scope of the present invention.

In a provide mobile communications device step 330, a mobile communications device with an associated connectivity application for gaining access to the server over an unlicensed wireless communication frequency spectrum is provided. The mobile communications device includes a client application module to encode and transmit speech samples to the server over the unlicensed wireless communication frequency spectrum. Although any type of mobile communications device can be provided and be within the intended scope of the present invention, a mobile phone with the requisite features would be a favored choice. The method concludes with an end step 340. Several other embodiments of methods of manufacturing an audience and speaker interaction communication system are claimed, each of which is readily apparent to those skilled in the pertinent art based on the description of the system provided herein.

Those skilled in the art to which the invention relates will appreciate that other and further additions, deletions, substitutions and modifications may be made to the described embodiments without departing from the scope of the invention.

What is claimed is:

1. An audience and speaker interactive communications system, comprising:
a server coupled to a loudspeaker, said server including an application module for receiving and decoding speech samples and transmitting said speech samples to said loudspeaker; and
a mobile communications device having a connectivity application for gaining access to said server over an unlicensed wireless communication frequency spectrum, said mobile communications device including a client application module for encoding and transmitting said speech samples to said server over said unlicensed wireless communication frequency spectrum.

2. The system as recited in claim 1 wherein said system utilizes Bluetooth™ applications.

3. The system as recited in claim 1 wherein said mobile communications device is a mobile phone.

4. The system as recited in claim 1 wherein said application module arbitrates between communications from two or more of said mobile communications devices.

5. The system as recited in claim 4 wherein said application module arbitrates based on the time of receipt of said communications.

6. The system as recited in claim 4 wherein said application module arbitrates based on user identity.

7. The system as recited in claim 1 wherein said server is selected from the group consisting of:
a laptop;
a palm PC;
a notebook; and
a personal computer.

8. A method of manufacturing an audience and speaker interactive communications system, comprising:
providing a server coupled to a loudspeaker, said server including an application module for receiving and decoding speech samples and transmitting said speech samples to said loudspeaker; and
providing a mobile communications device having a connectivity application for gaining access to said server over an unlicensed wireless communication frequency spectrum, said mobile communications device including a client application module for encoding and transmitting said speech samples to said server over said unlicensed wireless communication frequency spectrum.

9. The method as recited in claim 8 wherein said mobile communications device is a mobile phone.

10. The method as recited in claim 8 wherein a user of said mobile communications device gains access to said application module by registering said mobile communications device with said server.

11. The method as recited in claim 8 wherein said application module arbitrates between communications received from two or more of said mobile communications devices.

12. The method as recited in claim 11 wherein said application module arbitrates based on the time of receipt of said communications.

13. The method as recited in claim 11 wherein said application module arbitrates based on user identity.

14. The method as recited in claim 8 wherein said server is selected from the group consisting of:
a laptop;
a palm PC;
a notebook; and
a personal computer.

15. A mobile communications device for use with an audience and speaker interactive communications system, comprising:
a client application module, associated with said mobile communications device, for encoding and transmitting speech samples over an unlicensed wireless communication frequency spectrum; and
a connectivity application, associated with said mobile communications device, for gaining access to a server having an application module for receiving and decoding said speech samples and transmitting said speech samples to a loudspeaker.

16. The mobile communications device as recited in claim 15 wherein said server is coupled to said loudspeaker over said unlicensed wireless communication frequency spectrum.

17. The mobile communications device as recited in claim 15 wherein said mobile communications device is a mobile phone.

18. The mobile communications device as recited in claim 15 wherein said mobile communications device is a personal digital assistant.

19. The mobile communications device as recited in 15 wherein said mobile communications device is Bluetooth™ enabled.

20. The mobile communications device as recited in 15 wherein a user of said mobile communications device gains access to said server by registering said mobile communications device with said server.
